(19) United States
(12) Patent Application Publication
(10) Pub. No.: US 2022/0373130 A1
(43) Pub. Date: Nov. 24, 2022

(54) Compliant Railing Bracket

(71) Applicant: Ryan David Walker, Hayden, AL (US)

(72) Inventor: Ryan David Walker, Hayden, AL (US)

(21) Appl. No.: 17/321,450

(22) Filed: May 16, 2021

(51) Int. Cl. F16M 13/02; F16B 2/22

(52) U.S. Cl. CPC F16M 13/022; F16B 2/22; A47G 7/04

(57) ABSTRACT

A compliant railing bracket system in which useful or decorative items may be attached to various structural members without the use of fasteners, while utilizing a snap-fit method. The design utilizes a geometric configuration such that the bracket encompasses 3 faces of a rectangular structural member utilizing a cantilever snap-lock geometry to engage with the 4^{th} face creating a secure snap-fit junction. The bracket system may include modular attachment points such as dovetails or come as a pre-formed body with accommodations for various useful items such as flower box brackets, flower pots, solar light mounts, hooks, pegs, rings, tools and utensils.

### REFERENCES CITED

U.S. Pat. No. 7,341,230 (Beaudry)

PUB. NO.: US 2008/0099649 (Cavasos)

U.S. Pat. No. 8,870,163 (Regan)

### STATEMENT REGARDING FEDERALLY SPONSORED RESEARCH

Not Applicable

### THE NAMES OF THE PARTIES TO A JOINT RESEARCH AGREEMENT

Not Applicable

### STATEMENT REGARDING PRIOR DISCLOSURES BY THE INVENTOR

This invention was previously debuted to the public by the inventor making its first sale on May 16, 2020. A hyperlink to the place of sale is provided as follows: https://www.etsy.com/shop/Innovativ3DSolutions. Further evidence of the first sale can be referenced in FIG. 8 and FIG. 9, where screenshots were taken of the first orders received within the seller platform.

### BACKGROUND

The present invention allows users to utilize once unusable square footage of handrails and structural members by providing a simple non-damaging bracket to interface with structural members while providing the means to add useful items and decorations.

There is approximately 2.3 square feet of unusable space for every 8 feet of a 2×4 handrail and 3.6 square feet for every 8 feet of a 2×6 handrail. This unused space can become useable without the need of fasteners damaging the handrail when using this invention. The bracket further allows for the attachment of useful or decorative items in a modular way, or comes as a pre-formed variant designed such that accommodations are made for said useful or decorative items. The compliant nature of the design, along with the addition of cantilever snap-locks within the geometry allow for the bracket to be flexed around the structural member, pushed towards the furthermost face, before finally snapping into place around the structural member during installation. This method differs from various similar railing bracket systems which use fasteners or hooks that can damage the handrail, promoting a more permanent connection while also being a hassle to install.

The compliant nature of the present invention, allows for users to easily flex the bracket and install with minimal time and effort which can then be removed and re-installed thereafter. Once installed, the structural member also acts as a compressive reinforcement preventing the bracket from flexing inwards on itself while being loaded.

### FIELD OF INVENTION

This invention relates to a device used to mount an article to a structural member, including, but not limited to handrails constructed of common components.

More specifically, the invention relates to a device that is easily removable that encapsulates a structural member and utilizes a snap-lock mechanism to retain the bracket in position, in order to mount flower boxes, flower pots, pegs, hooks, rings or any related decorative or useful items.

### BRIEF SUMMARY

The compliant railing bracket is easily attached and removed to structural members of a wide variety in order to provide a means of attaching various decorative or useful objects such as planter boxes, flower pots, hooks, pegs, rings, tools, barbecue accessories and utensils. The compliant railing bracket is efficiently installed and removed without the use of tools of any sort, while maintaining the physical integrity of the structural member without leaving behind any sort of damage or scarring to the structural member or railing.

The compliant railing bracket is comprised of a simple geometry in which two mirrored cantilever snap-lock geometries joined by a third semi-flexible member perpendicular to the cantilever snap-locks provide a snap-lock junction between the bracket and the structural member. Installation merely requires the user to apply a bending force/moment to the cantilever snap-locks until they are spread open enough to begin accepting the structural member. Once the cantilever snap-locks are around the structural member, effectively pinching opposing faces of said structural member via the elastically deformed central perpendicular portion of the bracket exerting force, the bracket is merely pushed into place to the point where the cantilever snap locks engage with the remaining face of the structural member. The invention is designed such that it can be easily manufactured via the plastic injection molding process, effectively creating a low-cost, effective, and secure mounting solution to take advantage of the unused square footage of various decks, porches, balconies or other applications utilizing common structural components.

### DESCRIPTION OF RELATED ART

Devices for railing mounting solutions are known, yet achieve the end result in an impractical or alternative manner.

Pub. No.: US 2018/0125270 A1 (Hathaway) describes a device for hanging a flower box utilizing hook geometry that rests on the handrail creating a moment/rotational force in which the vertical portion of said handrail counteracts effectively creating a stable system for hanging articles from a railing.

U.S. Pat. No. 7,341,230 (Beaudry) utilizes a specialized bracket which encapsulated a structural member utilizing fasteners and a set screw to secure the connection. The bracket is then designed in a modular way to accept rod-like structures which accommodate for the addition of useful and decorative items such as flower boxes.

U.S. Pat. No. 5,320,319 (Winger) uses a simplistic flower box bracket, which again hangs the flower box off the outside railing, but relies completely on fasteners for its junction with a railing or structural member.

U.S. Pat. No. 5,423,504 (Shenkar) is another method for hanging a flower box off the side of a railing relying completely on fasteners at the junction point between the bracket and structural member.

U.S. Pat. No. 4,949,924 (Carmody) utilizes a hook shaped bracket method encapsulating the handrail relying on the handrail's vertical members to counteract the moment/rotational imbalance effectively hanging the flower box off the railing.

Pub. No.: US 2008/0099649 (Cavasos) is in fact the most applicable to the compliant railing bracket, but merely encapsulates the structural member with an oversized tolerance relying on a set screw to maintain position and stability.

### BRIEF DESCRIPTION OF THE DRAWING FIGURES

FIG. 1 depicts a schematic of the elevation view of the compliant railing bracket embodiment in which accommodations for a flower box are made as a pre-formed singular body as seen from the end of a structural 2×4 railing.

FIG. 2 depicts an elevation view schematic of the modular variant compliant railing bracket in which modular accommodations are made via dovetails being pre-formed for the addition of decorative or useful objects.

FIG. 3 depicts an elevation view of the installation of a modular variant of the compliant railing bracket, demonstrating the flexure that the bracket must undergo during installation.

FIG. 4 is a perspective view of the modular variant of the compliant railing bracket in conjunction with a standard 2×4 structural member.

FIG. 5 is a perspective view of the modular variant of the compliant railing bracket in conjunction with a standard 2×6 structural member.

FIG. 6 is a perspective view of the modular variant of the compliant railing bracket in conjunction with a standard 4×4 structural member.

FIG. 7 depicts a schematic of the elevation view of the modular compliant railing bracket fixed to a 2×4 with the addition of a useful modular flower box retaining mount attachment.

### DETAILED DESCRIPTION

The inventor provides a unique compliant modular bracket system that is intended to be used in conjunction with common handrails and structural building materials. The new state-of-the-art [symbol] -shaped system is designed in such a way by geometry and material choice that the bracket will be compliant enough to be manually stretched open and slid over the handrail until the lowermost cantilever snap-locks engage with the bottom of the handrail creating a snap-fit joint with the bottom edge of the structure; yet rigid enough to provide for a structurally sound junction. The present invention is described in enabling detail in the following examples, which may represent more than one embodiment of the present invention.

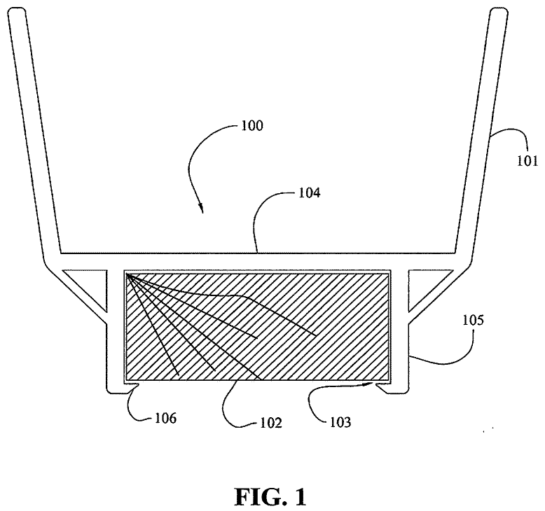

FIG. 1 is an elevation view of a more specific version of the compliant railing bracket system being used as a planter box mounting solution. Within the configuration 100, the bracket is fit to a standard wooden 2×4 102. The 101 element acts as a boundary for the planter box to ensure it does not become displaced by the elements. The bracket is designed in such a way either by material choice and/or geometrical thickness, that the center most portion of the geometry 104, which sees the highest bending stress during installation, does not exceed the yield stress of the material and behaves elastically while being installed by the user.

In this embodiment the user elastically bends the bracket just enough for the cantilever snap-locks 106 to clear the width of the structural member whilst pushing down. The bracket will then slide down around the structural member until finally the latching protrusions clear the bottom most face of the structural member, where the snap-locks will latch into place relieving the bending stress upon 104 and creating a rigid snap-fit junction with the structural member.

The vertical legs 105 act not only as a boundary to the structural member, but also as a means of preventing tipping motions in the lateral direction as it will experience tensile stresses during such an event due to the engagement of 106. Those experienced in the art would also note that special care must be taken during design to provide an adequate tolerance 103 to accommodate for the slight variations amongst structural members from various regions.

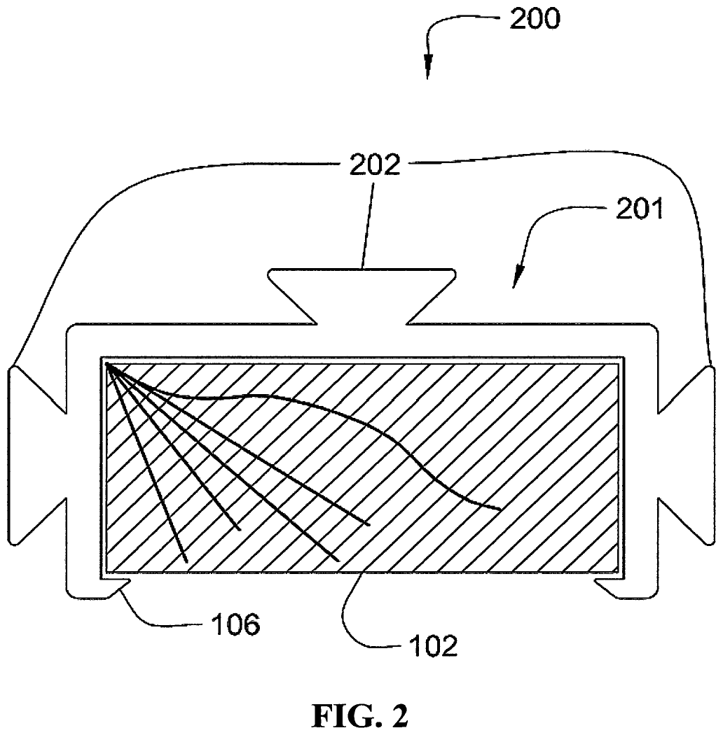

FIG. 2 is an elevation view of a modular embodiment of the compliant railing bracket system. In this assembly example 200 the bracket still functions in the same manner as 100 with 106 creating a snap-fit junction between the bracket and structural building materials 102, but with the addition of dovetails on each of the three faces 202. The use of dovetails on the bracket 201 allows for a more modular approach in which nearly endless amounts of attachment variations can be mounted with ease. The modular brackets would therefore be unique only in the aspect to the geometries and/or dimensions of the particular structural member in which they were intended.

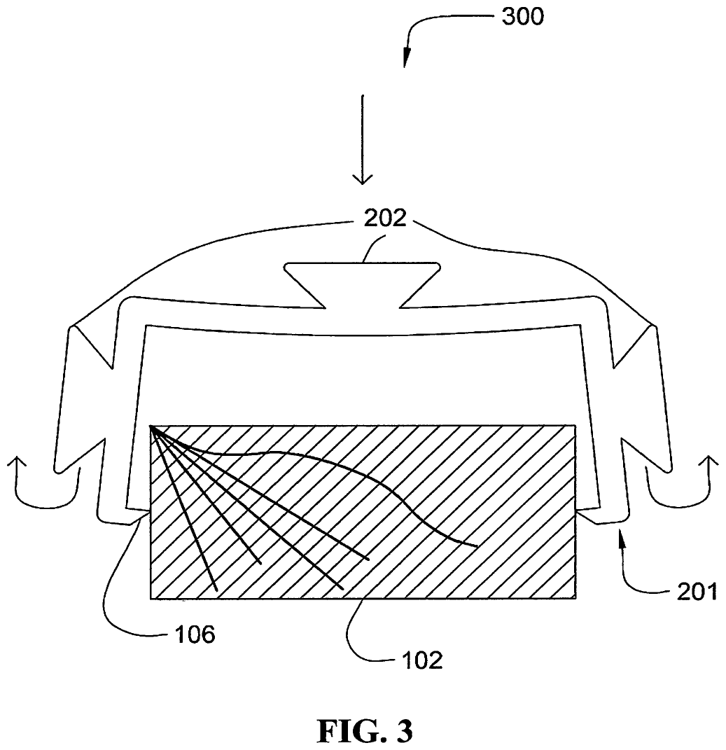

FIG. 3 is an elevation view of the installation process for the modular embodiment of the invention. The assembly 300 shows how the bracket 201 should be opened via exerting a moment force upon the bounding vertical cantilever snap-locks until the point in which 106 clears the width of the structural member 102, in which the central dovetail 202 can then be pressed down to where it slides amongst the vertical face of 102 until 106 reaches the bottom and creates a snap fit joint.

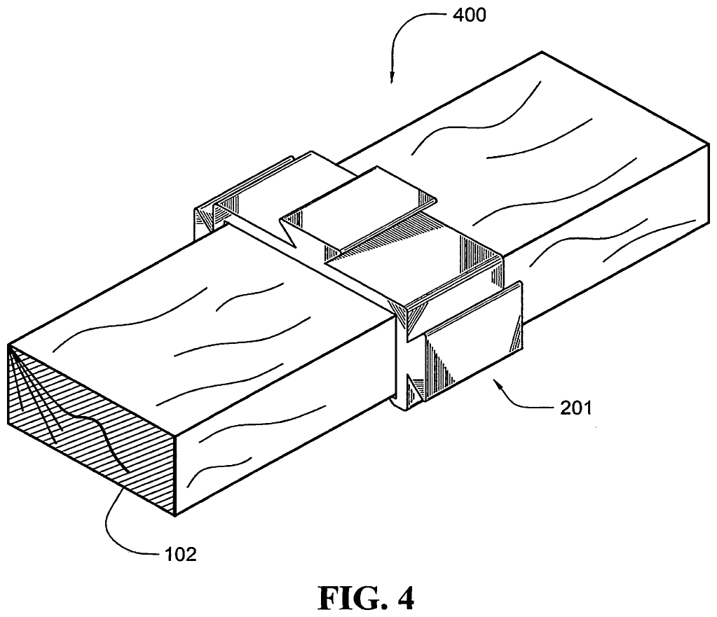

FIG. 4 is a perspective view of modular embodiment of the compliant railing bracket fitted to a standard wooden 2×4. This assembly 400 is an example of the bracket 201 being unique to the structural member 102, which in this case is a standard 2×4.

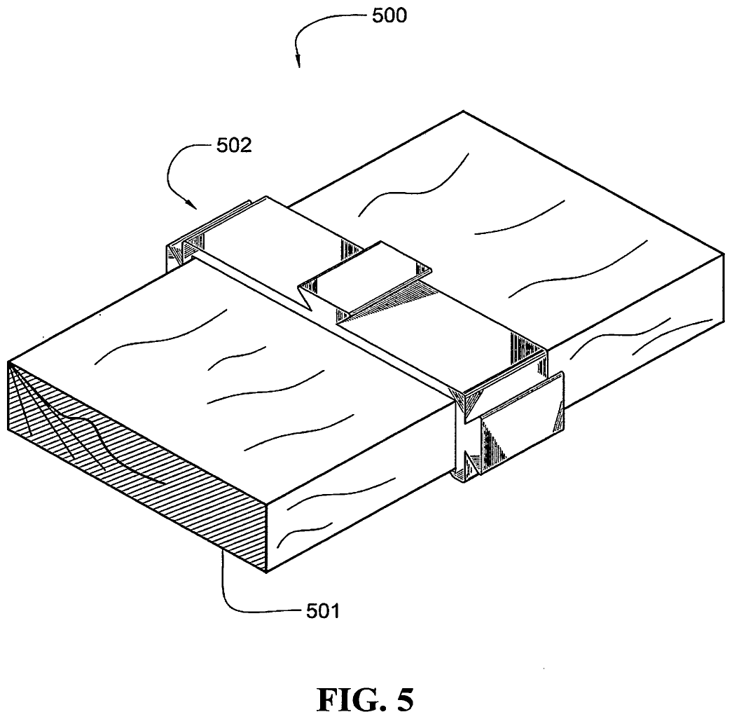

FIG. 5 is a perspective view of modular embodiment of the compliant railing bracket fitted to a standard wooden 2×6. This assembly 500 is an example of the bracket 502 being unique to the structural member 501, which in this case is a standard 2×6.

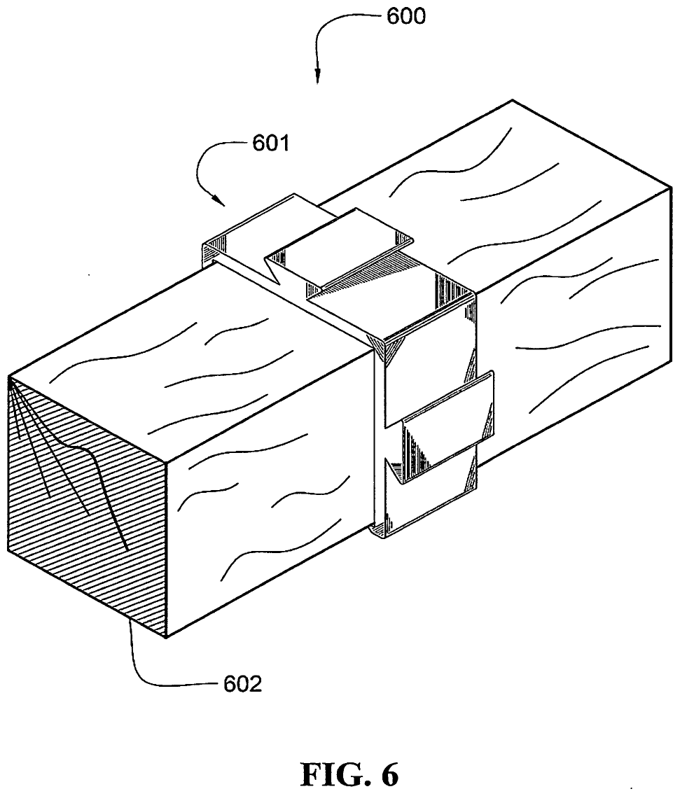

FIG. 6 is a perspective view of modular embodiment of the compliant railing bracket fitted to a standard wooden 4×4. This assembly 600 is an example of the bracket 601 being unique to the structural member 602, which in this case is a standard 4×4. One can see that having the compliant railing bracket being unique only to the structural member, yet sharing the same dimensional modular attachment points as noted by 202 in FIG. 2; the attachments can all be shared amongst the brackets that vary only in the accommodations for which the structural member they were intended.

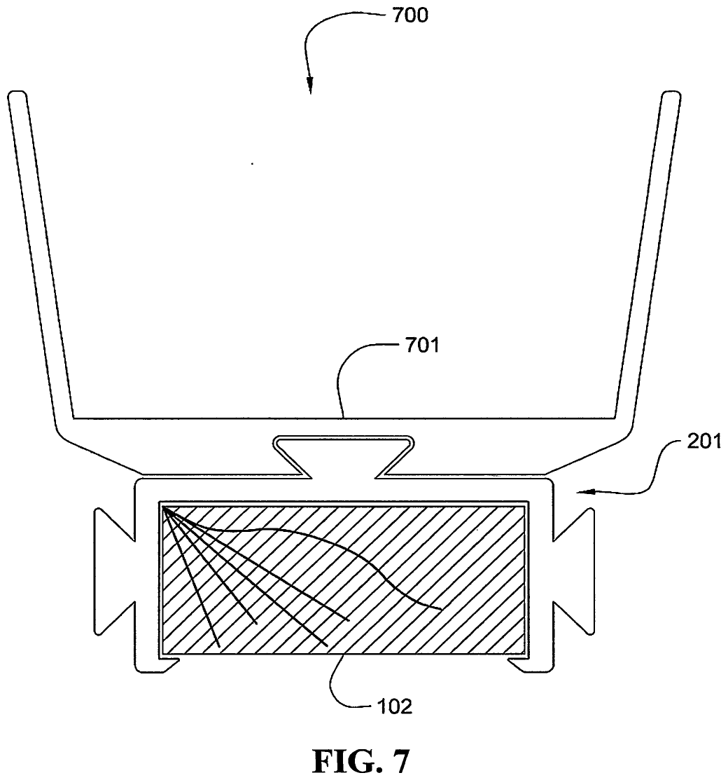

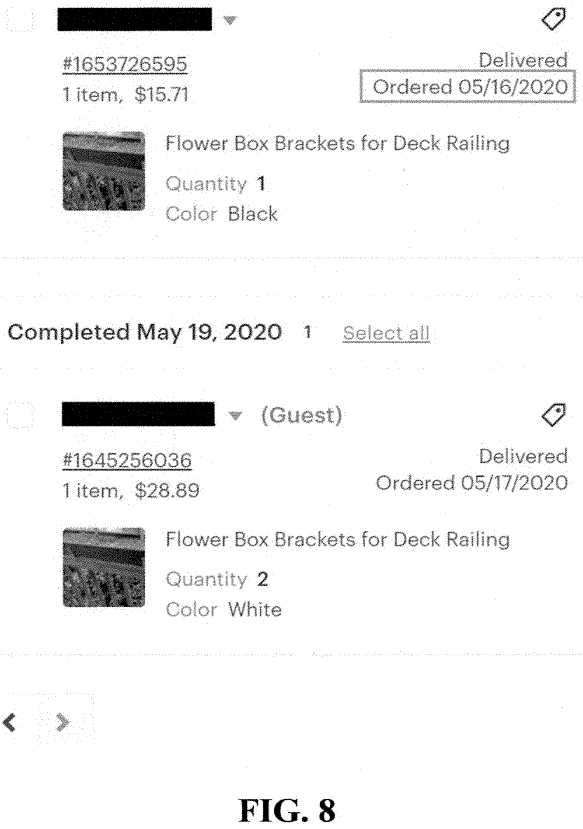

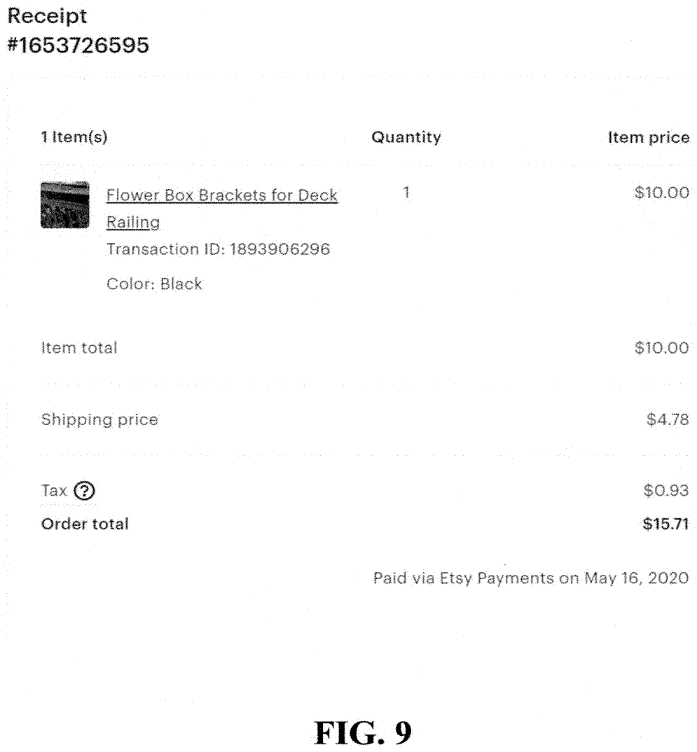

FIG. 7 is an elevation view depicting the use of an attachment for the modular compliant bracket system. The attachment 701 shown in assembly 700 accomplishes the same task as shown in 100, but with the use of the modular embodiment 201 affixed to 102. This alternative approach depicts that nearly unlimited combinations and variations of attachments can be used in conjunction with the modular embodiment 201 allowing the consumer to effectively make use of once unusable square footage.

1. A bracket for connection to structural members utilizing a snap-lock method while encapsulating opposing faces of said structural members with cantilever snap-lock geometries which engage with the furthermost face or faces creating a snap-fit joint between the bracket and the structural member.

2. A bracket according to claim 1, further comprising a semi-flexible material, geometry, or any combinations thereof to allow for flexure during installation, yet rigid enough to provide a secure connection.

3. The bracket according to claim 1, comprising of two male cantilever snap lock geometries mirrored from one another, while offset an appropriate distance relative to the width of the intended structural member of application.

4. The bracket according to claim 1, further comprising of a perpendicular and/or adjacent pre-formed member, effectively joining two male cantilever snap lock geometries within the offset constraints of the structural member.

6. The bracket according to claim 1, wherein said compliant railing bracket is constructed from compliant materials consisting of metals, plastics, composite materials, and any combinations thereof.

7. The bracket according to claim 1, comprising of a coinciding geometric thickness or arrangement and material combination, so as to not exceed the yield stress of the material while bending during installation.

8. The bracket according to claim 1, wherein the bracket is configured for vertical orientation with the addition of a set screw.

9. The bracket according to claim 1, wherein said structural members comprise of metal, wooden, stone, brick, or concrete; having a rectangular or partially rectangular cross-section.

10. The bracket according to claim 1, wherein said metal or wooden structural members comprise of members with nominal sizes: 1″×4″, 1″×6″, 2″×2″, 2″×4″, 2″×6″, 2″×8″, 2″×10″, 4″×4″, 4″×6″, and 6″×6″.

11. A pre-formed assembly according to claim 1, comprising of accommodations for the addition of a decorative or useful object.

12. A pre-formed assembly according to claim 1, comprising of modular attachment methods for decorative or useful objects.

13. The pre-formed assembly according to claim 11, wherein said decorative or useful object is a flower box, solar light mount, cutting board, pegs, hooks, eyelets, rings or flower pot.

13. The pre-formed assembly according to claim 12, wherein decorative or useful objects are attached in a modular way comprising of dovetails or other means of attachment.
